(19) United States
(12) Patent Application Publication
(10) Pub. No.: US 2002/0008341 A1
(43) Pub. Date: Jan. 24, 2002

(54) Hydraulic vibration isolator

(75) Inventors: Norihiro Yamada, Aichi-ken (JP); Tatsuo Suzuki, Aichi-ken (JP); Keiji Miyoshi, Aichi-ken (JP); Osamu Hattori, Ohbu-shi (JP); Hiroyuki Nunome, Ohbu-shi (JP)

Correspondence Address: PILLSBURY WINTHROP LLP, 1600 TYSONS BOULEVARD, MCLEAN, VA, 22102, US

(73) Assignee: TOYODA GOSEI CO., LTD.

(21) Appl. No.: 09/909,894

(22) Filed: Jul. 23, 2001

(30) Foreign Application Priority Data
Jul. 21, 2000 (JP) 2000-220282

(51) Int. Cl. F16M 9/00; F16F 13/00

(52) U.S. Cl. 267/140.11

(57) ABSTRACT

Between the first linking member mounted on the vibrating body side and the second linking member mounted on a member on the car body side, the hydraulic vibration isolator has an insulator for isolating vibrations from the vibrating body. The main and auxiliary chambers in which an incompressible fluid (liquid) is sealed are provided in series with this insulator. The liquid is allowed to flow between the main chamber and the auxiliary chamber through an orifice. The partition member separates the main chamber and the auxiliary chamber from each other. The diaphragm forms a part of the chamber wall of the auxiliary chamber and separates the auxiliary chamber from an external atmosphere. The partition member is formed with a communication passage that connects the main chamber with the auxiliary chamber. In the communication passage is arranged a vibrator comprising an oscillating piston that oscillates the liquid in the main chamber at a predetermined frequency. The electromagnetic rotary actuator drives the oscillating piston of the vibrator. The rotating shaft of the rotary actuator is supported with a small frictional loss.

### BACKGROUND OF THE INVENTION

The present invention relates to a hydraulic vibration isolator, and more particularly to a hydraulic vibration isolator with a vibrator which has an oscillating piston installed in a communication passage formed between a main chamber and an auxiliary chamber and driven by a rotary actuator. The vibrator is operated at a particular frequency to vibrate a liquid in the main chamber to change a dynamic spring constant of the vibration isolator for a vibration input of that particular frequency.

Among vibration isolators, an automotive engine mount in particular must be able to cope with a wide range of vibration frequencies because the engine as a driving source is operated under a variety of circumstances from an idling state to a maximum revolution speed. To deal with a plurality of these conditions, a hydraulic vibration isolator has already been in use, which has a liquid chamber therein and a vibrator, comprising an oscillating piston for instance, for vibrating the liquid in the liquid chamber at a particular frequency. The conventional hydraulic vibration isolator, however, depends primarily on a negative pressure, such as a suction pressure in the engine, to drive the vibrator. This conventional vibration isolator has drawbacks that the operation of the oscillating piston is difficult to control and that it is difficult to obtain a sufficiently large force generated by the vibrator.

To solve the problems mentioned above, a hydraulic vibration isolator has been proposed which employs an electromagnetic rotary actuator as a drive source for the vibrator. This vibration isolator is described in Japanese Patent Application No. 11-244217, commonly assigned and corresponding to Japanese Patent Unexamined Publication No. 2001-65629 and copending U.S. patent application Ser. No. 652,214, the latter being incorporated herein by reference.

The vibrator of Japanese Patent Application No. 11-244217, as shown in FIG. 9, is installed in a communication passage 50 connecting a main chamber 20 and an auxiliary chamber 30 and mainly comprises an oscillating piston 10. In the vibrator of this construction, to increase a vibrating force acting on the liquid in the main chamber 20 requires increasing a pressure receiving area of the oscillating piston 10. This in turn requires increasing the capacity of a motor or actuator 40 for driving the oscillating piston 10. In this vibrator, a shaft 110, attached with the oscillating piston 10 and a permanent magnet 450 constituting the actuator 40, is supported at its ends by ball bearings 120, 130. Further, the shaft 110 is also provided with an oil seal 150 near the bearing 130 on the actuator 40 side for sealing the liquid from the liquid chambers 20, 30. The shaft 110 is subjected to a frictional force of the oil seal 150 at all times. As a result, also to deal with this frictional force (friction loss), the output of the actuator 40 needs to be made large, resulting in an increase in the overall size of the hydraulic vibration isolator.

### BRIEF SUMMARY OF THE INVENTION

In light of the above, an object of the present invention is to provide a hydraulic vibration isolator that supports the shaft with a bearing system having a small frictional loss and which does not need to use the oil seal described above.

The hydraulic vibration isolator according to this invention has a first connecting or linking member adapted to be mounted to a vibrating body side, a second connecting or linking member adapted to be mounted to a member on a car body side,, an insulator installed between the first and second linking members to isolate vibrations from the vibrating body, a main chamber defined by a chamber wall and sealed with a liquid or incompressible fluid, the chamber wall being partly formed by a part of the insulator, an auxiliary chamber defined by a chamber wall and communicating with the main chamber through an orifice, the chamber wall being partly formed by a diaphragm, a partition member separating the main chamber and the auxiliary chamber from each other, a communication passage passing through the partition member to allow the liquid to flow between the main chamber and the auxiliary chamber, and a vibrator for vibrating the liquid in the main chamber at a predetermined frequency. The vibrator includes an oscillating piston installed in the communication passage, an electromagnetic rotary actuator to drive the oscillating piston at a predetermined frequency, and a rotating shaft connecting the oscillating piston with the rotary actuator. The rotary actuator has a permanent magnet making up a part of the rotary actuator and mounted to the rotating shaft. This hydraulic vibration isolator is characterized in that the oscillating piston and the rotating shaft are supported by a bearing portion and a holding portion, that the bearing portion includes a planar bearing and a journal portion engaging the planar bearing, that the journal portion is so formed as to introduce the liquid between the planar bearing and the journal portion, and that the holding portion is provided on the side of one end portion of the rotating shaft to hold the one end portion rotatably.

With this construction, the rotating shaft on which the oscillating piston is mounted is rotatably supported with a small frictional resistance, which in turn reduces the frictional loss during the operation of the oscillating piston. To describe in more detail, the planar bearing forming the main part of the rotating shaft support portion is supplied a liquid, which performs a function of a lubricating oil, to form a lubricating oil film around the journal portion. This reduces the frictional loss of the rotating shaft.

Another aspect of the present invention provides a hydraulic vibration isolator which, in addition to the construction described above, has iron pieces provided around the permanent magnet and offset from the permanent magnet in the axial direction of the rotating shaft by a predetermined distance to produce a magnetic force acting between the permanent magnet and the iron pieces to force the rotating shaft toward the holding portion side.

In this construction, when the electromagnetic rotary actuator is operated, i.e., the coil is energized by the electric current flowing through it, the magnetic force thus generated moves the permanent magnet and the rotating shaft mounted with the permanent magnet in the axial direction of the rotating shaft toward the line contact portion. As a result, the rotating shaft is more reliably supported at the line contact portion (holding portion), making the operation of the rotating shaft and the oscillating piston smooth.

Still another aspect of the present invention provides a hydraulic vibration isolator which is characterized in that, in addition to the construction described first, the permanent magnet is; mounted to the rotating shaft by a mechanical fastening device without using an adhesive. With this mounting structure of the permanent magnet, there is no need for an oil seal for sealing a liquid. This achieves a further reduction in the frictional loss of the rotating shaft.

The holding portion preferably includes the line contact portion formed in a plane perpendicular to the axis of the rotating shaft. This construction can reduce the frictional loss of the holding portion, realizing a further reduction in the overall frictional loss of the rotating shaft support portion.

The line contact portion preferably includes one of two combinations, the two combinations comprising a combination of a spherical portion provided at a front end portion of the rotating shaft and a conical surface provided on the partition member side to engage the spherical portion and a combination of a conical portion formed at a front end side of the rotating shaft and a rotation defining raised surface, the rotation defining raised surface being provided on the partition member side, formed of a rotation defining surface of a raised curved portion, and adapted to engage the conical portion. With this construction, the line contact portion can be formed in a simple engagement structure of the spherical portion or raised surface portion and the conical surface. Not only does this structure reduce the frictional force but the overall construction can also be simplified.

The journal portion is advantageously provided on the rotating shaft and the outer surface of the rotating shaft at the journal portion is formed with a recess to introduce the liquid. With this construction, the liquid having the function of a lubricating oil is introduced into the recess to form a lubricating oil film between the journal and the planar bearing. The frictional loss of the rotating shaft is therefore reduced.

Alternatively, the outer surface of the rotating shaft at the journal portion may be formed with a spiral groove to introduce the liquid. With this construction, the liquid with the lubricating function is interposed between the journal portion and the planar bearing, thereby reducing the frictional loss of the journal portion, i.e., the rotating shaft, as with the case of the recess.

Alternatively, the outer surface of the rotating shaft at the journal portion may be surface-textured to introduce the liquid between the outer surface of the rotating shaft and the planar bearing, or its surface roughness may be increased. This construction can minimize the frictional loss of the rotating shaft, as with the case of the recess and the spiral groove. That is, the liquid with the lubricating function exists at all times between the journal portion of the rotating shaft and the planar bearing that supports the journal portion, thereby reducing the frictional loss of the journal portion.

### BRIEF DESCRIPTION OF THE SEVERAL VIEWS OF THE DRAWING

These and other features and advantages of the present invention will be more apparent from the following description when taken in conjunction with the accompanying drawings, in which:

FIG. 1 is a vertical cross section showing an overall construction of the hydraulic vibration isolator as one embodiment of the invention;

FIG. 2 illustrates a first example of a bearing portion of the vibration isolator of FIG. 1 according to the invention;

FIG. 3 illustrates a second example of the bearing portion of the vibration isolator of FIG. 1 according to the invention;

FIG. 4 illustrates a third example of the bearing portion of the vibration isolator of FIG. 1 according to the invention;

FIG. 5 is an exploded perspective view showing how the permanent magnet of the vibrator is assembled;

FIG. 6 is a vertical cross section showing an overall construction of the hydraulic vibration isolator as another embodiment of the invention using a line contact portion of another structure;

FIG. 7 is a cross section showing another example of the line contact portion in the vibration isolator of FIG. 1 according to the invention;

FIG. 8 is a cross section showing another construction of the permanent magnet and its associated components in the vibration isolator of FIG. 1 or FIG. 6 according to the invention; and

FIG. 9 is a vertical cross section showing an overall construction of a conventional vibration isolator.

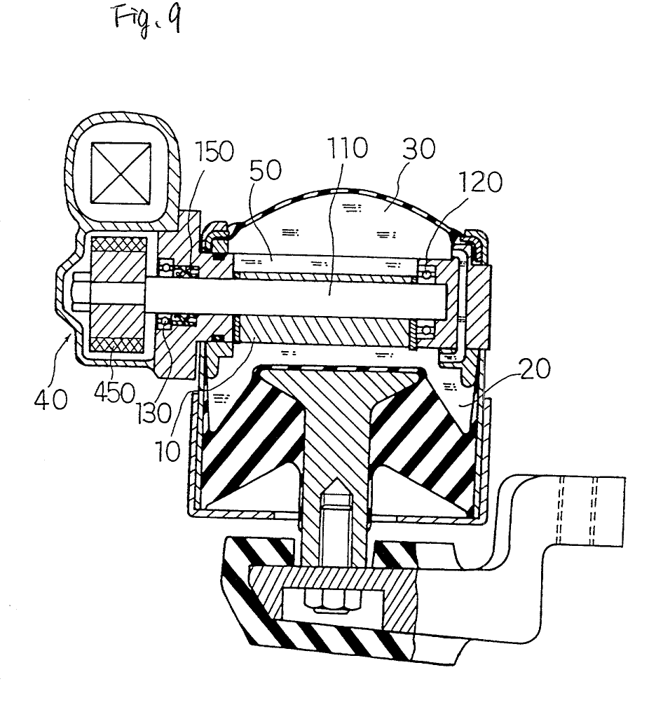

### DETAILED DESCRIPTION OF THE INVENTION

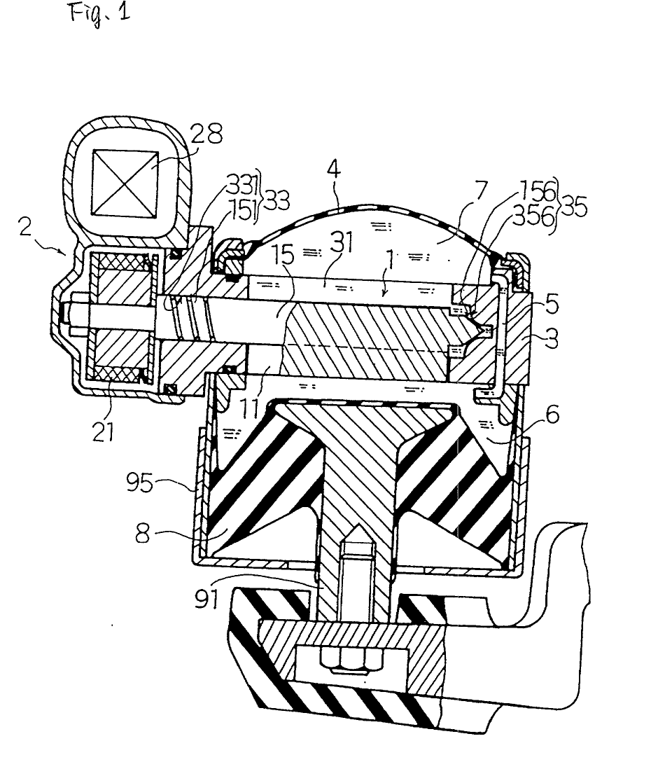

Embodiments of the hydraulic vibration isolator according to the present invention will be described by referring to FIGS. 1 through 8.

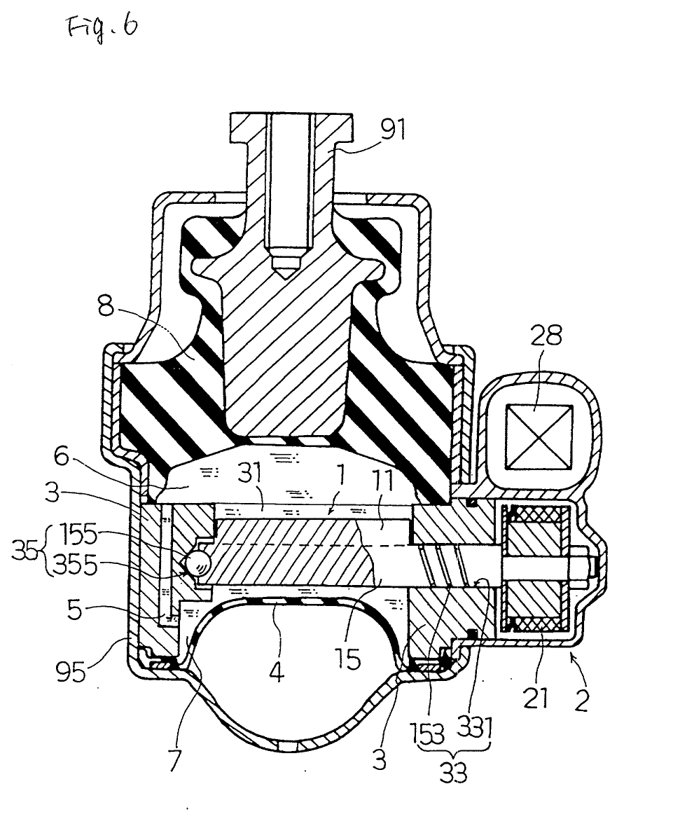

The vibration isolators according to the embodiments of this invention each basically include, as shown in FIG. 1 or FIG. 6, a first connecting or linking member 91 mounted on a vibrating body side; a second connecting or linking member 95 mounted to a member on a car body side; an insulator 8 installed between the first linking member 91 and the second linking member 95 to isolate vibrations from the vibrating body; a main chamber 6 and an auxiliary chamber 7, both provided in series with the insulator 8 and sealed with a liquid or incompressible fluid; a partition member 3 separating the main chamber 6 and the auxiliary chamber 7 from each other; an orifice 5 connecting the main chamber 6 and the auxiliary chamber 7 to allow the liquid to flow between the two chambers; and a diaphragm 4 forming a part of a wall of the auxiliary chamber 7 to seal the chamber from the atmosphere. The vibration isolators also have a communication passage 31 passing through the partition member 3 and a vibrator 1 to vibrate the liquid in the main chamber 6 at a particular frequency. The vibrator 1 mainly comprises an oscillating piston 11 arranged in the communication passage 31 and also has an electromagnetic rotary actuator 2 to drive the oscillating piston 11. An antifreeze is used as the liquid sealed in the vibration isolator.

In addition to the oscillating piston 11, the vibrator 1 has a rotating shaft 15 provided in the communication passage 31. The rotating shaft 15 is connected to the electromagnetic rotary actuator 2. The oscillating piston 11 is mounted to the rotating shaft 15 and projects radially outwardly. The oscillating piston 11 is fan-shaped in cross section to conform to the communication passage 31 and is formed integral with the rotating shaft 15. The rotating shaft 15 is rotatably supported at a line contact portion 35 on the front end side of the rotating shaft and at a bearing portion 33 on the rotary actuator side, as shown in FIG. 1. The line contact portion 35 comprises a conical portion 156 at the end of the rotating shaft 15 and a rotation defining raised surface 356 that engages the conical portion 156. The bearing portion 33 comprises a journal portion 151 formed on a part of the rotating shaft 1!5 and a planar bearing 331 that engages the journal portion 151.

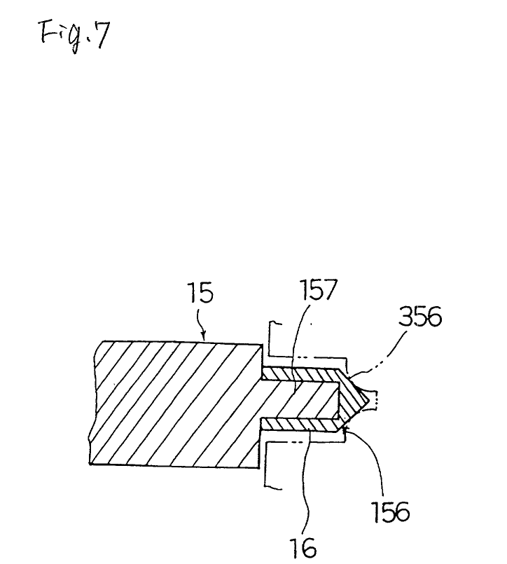

In more concrete terms, the conical portion 156 may be provided by a cap 16 which encloses and is secured to a front end 157 of the rotating shaft 15, as shown in FIG. 7. The cap 16 is made from a metal such as brass. Alternatively, the conical portion 156 may also be made by plating brass over the surface of the front end 157. The receiving side which engages and is in line contact with the conical portion 156 has the rotation defining raised surface 356 that is formed by rotating a raised curved portion with a predetermined curvature about an axis of the rotating shaft 15, as shown in FIG. 1 and FIG. 7.

Alternatively, as shown in the embodiment of FIG. 6, the holding portion or line contact portion 35 may be constructed of a spherical face portion 155 provided on the rotating shaft 15 side and a conical face 355 on the receiving portion side formed in the partition member 3. In that case, the spherical face portion 155 is formed by driving or embedding a steel ball of a predetermined size into the front end portion of the rotating shaft 15.

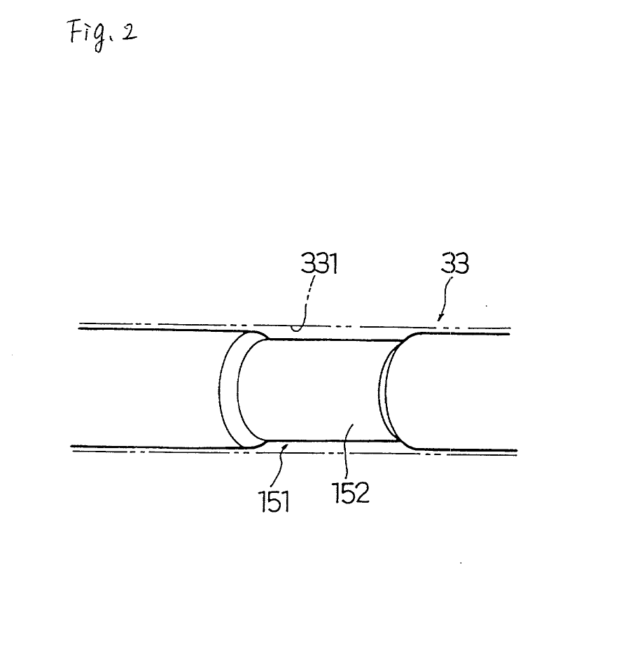

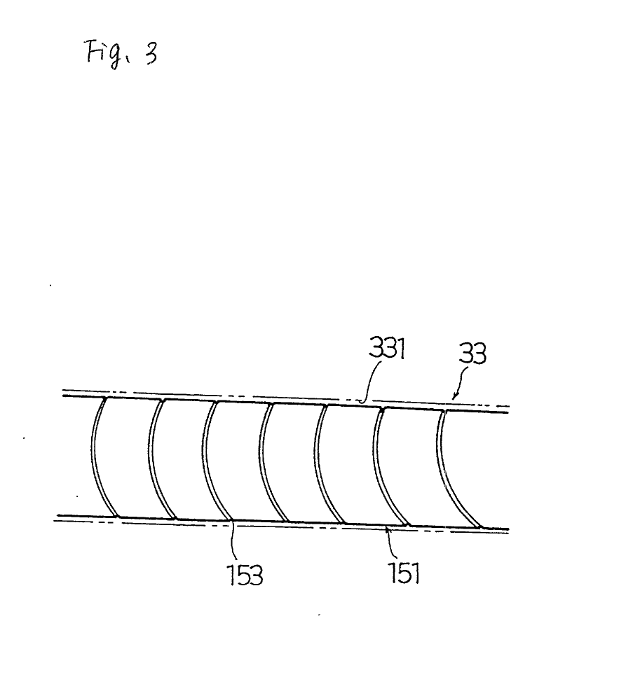

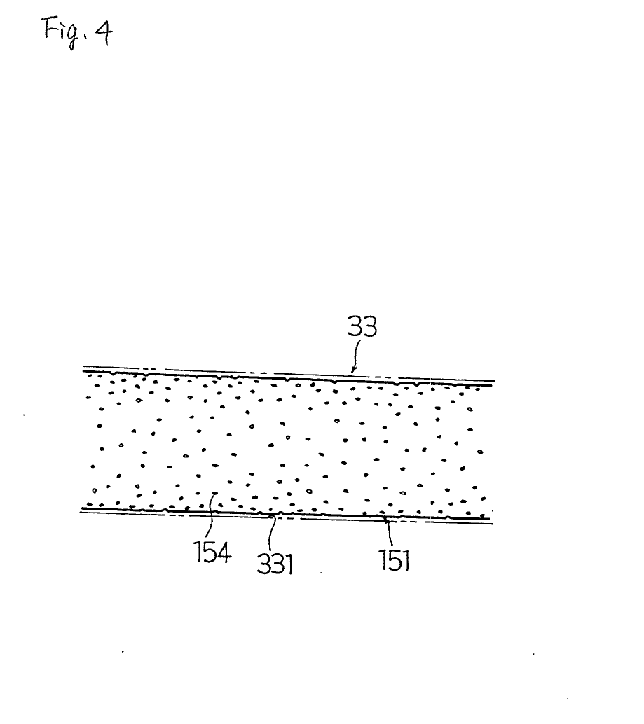

Next, the detailed construction of the bearing portion 33 will be described by referring to FIGS. 2 to 4. FIG. 2 shows a recessed portion 152 as an oil retaining portion formed in the outer surface of the journal portion 151. The recessed portion 152 may be provided in plural numbers on the circumferential surface. What is required is that the journal portion 151 retains a liquid to form a lubricating film over its outer surface. FIG. 3 shows another example of the journal portion 151 that has a spiral groove 153 as an oil retaining portion formed in its outer surface. Shown in FIG. 4 is still another example of the journal portion 151 which is formed with a pattern 154 on its outer surface consisting of innumerable fine depressions and protrusions. Rather than forming such a pattern 154 or performing surface texturing, the surface roughness of the journal portion 151 may be increased to produce an effect similar to that of the surface texturing. The essential requirement is that innumerable fine depressions and protrusions are formed on the outer surface of the journal portion 151 as by surface texturing to form a large number of oil retaining portions between the journal portion 151 and the planar bearing 331 that engages it, thus forming a lubricating film on the bearing portion 33.

The electromagnetic rotary actuator 2 for driving the rotating shaft 15 and the oscillating piston 11 at a predetermined frequency basically comprises, as shown in FIG. 1 and FIG. 6, a cylindrical permanent magnet 21 attached to one end of the rotating shaft 15 and a coil 28 for rotating the permanent magnet 21 at a predetermined frequency. The coil 28 is provided around the permanent magnet 21 to oscillate it. In this embodiment the permanent magnet 21 is mechanically secured to one end portion of the rotating shaft 15. That is, the permanent magnet 21 is mounted without an adhesive. Thus, if the liquid present around the oscillating piston 11 seeps into the area of the permanent magnet 21, no particular problem arises and there is no need to provide an oil (seal around the rotating shaft 15 to prevent infiltration of the liquid. Hence, the frictional loss around the rotating shaft 15 can be kept low.

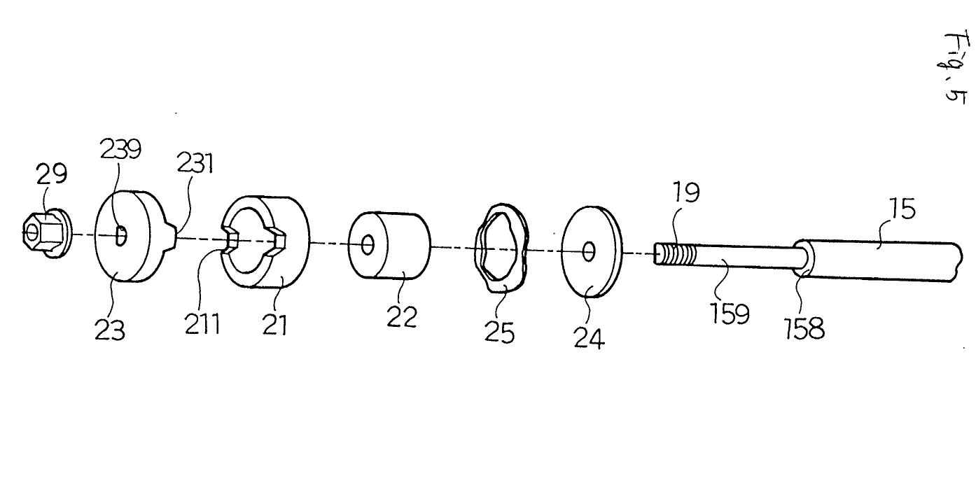

Now, the mechanical fixing of the permanent magnet 21 will be explained in detail. As shown in FIG. 5, the rotating shaft 15 has at its front end a stepped portion 158 and a narrow-diameter support portion 159 extending forwardly beyond the stepped portion. A front end of the narrow-diameter support portion 159 is provided with an external thread portion 19. The external thread portion 19 is D-shaped in lateral cross section when viewed from the front. A disklike plate 24 is sleeved over the narrow-diameter support portion 159 until it engages the stepped portion 158. Then, a ring-shaped leaf spring 25 is also sleeved over the support portion 159 so it engages the plate 24. The leaf spring 25 has a function of fixing the permanent magnet 21 to be attached later in the axial direction of the rotating shaft 15. Next, a cylindrical magnetic iron spacer 22 is attached over the support portion 159. To the outside of this spacer 22 is attached a cylindrical hollow permanent magnet 21. Then, a rotation prevention plate 23 is placed in contact with the end of the permanent magnet 21. Finally, a nut 29 is screwed over the external thread portion 19 at the front end of the rotating shaft 15 projecting from the rotation prevention plate 23 and is then tightened.

In this way, the permanent magnet 21 is secured to the support portion 159 at one end of the rotating shaft 15 by the aforementioned mechanical fastening means. The permanent magnet 21 has a recessed portion 211 formed on one side facing the rotation prevention plate 23, and the rotation prevention plate 23 has a raised portion 231 formed on one side contacting the permanent magnet 21 to engage the recessed portion 211 of the permanent magnet 21. An opening 239 in the rotation prevention plate 23 is D-shaped in cross section so that it can fitted over the external thread portion 19 which has a similar D-shaped cross section. Hence, when the nut 29 is fastened, the permanent magnet 21 is held immovable with respect to the external thread portion 19 of the support portion 159 through the rotation prevention plate 23. The permanent magnet 21 is now prevented from being turned.

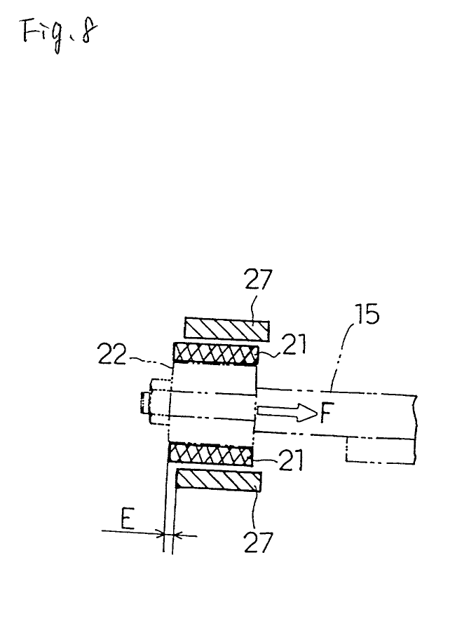

Iron pieces 27 of a predetermined shape may be arranged at equal intervals around the permanent magnet 21, as shown in FIG. 8. These iron pieces 27 are offset from the permanent magnet 21 by a predetermined distance (E) in the axial direction of the rotating shaft 15. With this arrangement,-when the electromagnetic rotary actuator 2 is operated, i.e., when the coil 28 is energized by the current flowing through it, the permanent magnet 21 and the rotating shaft 15 are pushed in the axial direction toward the line contact portion 35, i.e., in the direction of arrow F of FIG. 8. This makes the supporting of the rotating shaft 15 by the line contact portion or holding portion 35 in FIG. 1 and FIG. 6 more reliable, allowing the rotating shaft 15 and the oscillating piston 11 to operate smoothly. The elements 27 are not limited solely to the iron pieces but may be made of any other magnetic material which is attracted by a magnetic force of the permanent magnet 21.

Next, the operation of the vibration isolator of the above construction shown in FIG. 1 or FIG. 6 will be explained. As already described, the vibrator 1 for oscillating the liquid in the main chamber 6 is provided in the partition member 3 that separates the main chamber 6 and the auxiliary chamber 7 from each other. The oscillating piston 11 of the vibrator 1 is driven at a predetermined frequency by the electromagnetic rotary actuator 2. When the input vibration is an engine idling vibration, for example, the oscillating piston 11 of the vibrator 1 is operated by the electromagnetic rotary actuator 2. The vibrator 1 applies vibrations to the liquid on the main chamber side of the partition member 3 to vibrate the liquid in the main chamber 6 and thereby absorb a pressure increase of the liquid in the main chamber 6 caused by the engine idling vibration transferred through the insulator 8. As a result, the dynamic spring constant of a spring system formed by the hydraulic vibration isolator decreases, thus absorbing and isolating the engine idling vibration.

In this series of operations of the hydraulic vibration isolator of this invention, because the rotating shaft 15 mounted with the oscillating piston 11 is supported by the line contact portion 35 with a small frictional resistance and by the bearing portion 33 with an excellent lubricating performance, the frictional loss of the rotating shaft 15 during the operation of the oscillating piston 11 can be kept low. Hence, the output of the rotary actuator 2 can be extracted efficiently. In addition, the isolator of the embodiment above uses no adhesive in mounting the permanent magnet 21 making up the rotary actuator 2, so that the infiltration of the liquid into the area of the permanent magnet 21 does not pose any problem, making it unnecessary to provide a sealing means such as oil seal around the rotating shaft 15. This in turn can keep the frictional loss of the rotating shaft 15 low and extract the output of the rotary actuator 2 efficiently. As a result, it is possible to use a small rotary actuator 2, leading to a reduction in size and weight of the hydraulic vibration isolator.

The bearing portion 33 has a construction, as shown in FIG. 2 to FIG. 4, in which the liquid is introduced between the journal portion 1!51 and the planar bearing 331 to form a lubricating film of the liquid. This construction enhances the Lubricating function of the bearing portion 33, suppressing the frictional loss of the rotating shaft 15.

As described above, with the construction of this invention, driving the vibrator at a predetermined frequency can reduce the dynamic spring constant of the spring system of the hydraulic vibration isolator for a vibration input such as engine idling vibration as required, thus absorbing and isolating the engine idling vibration.

Further, because the rotating shaft of the vibrator is supported by the line contact portion with a small friction resistance and by the bearing portion with an excellent lubricating performance, the frictional loss of the rotating shaft during the operation of the oscillating piston can be minimized. This in turn allows the output of the rotary actuator to be extracted efficiently, leading to a reduction in size and weight of the hydraulic vibration isolator.

Further, because the permanent magnet of the rotary actuator is mounted without using adhesive, there is no need to provide a sealing means around the rotating shaft. This minimizes the frictional loss of the rotating shaft, which also ensures efficient extraction of the output of the rotary actuator. This in turn allows the use of a small rotary actuator, reducing the size and weight of the hydraulic vibration isolator. Further, the simplified construction of the bearing portion and its associated components with no sealing means such as oil seal used can reduce the manufacturing cost of the vibration isolator.

1. A hydraulic vibration isolator comprising:
a first linking member adapted to be mounted to a vibrating body side;
a second linking member adapted to be mounted to a member on a car body side;
an insulator installed between the first and second linking members to isolate vibrations from the vibrating body;
a main chamber defined by a chamber wall and sealed with a liquid or incompressible fluid, the chamber wall being partly formed by a part of the insulator;
an auxiliary chamber defined by a chamber wall and communicating with the main chamber through an orifice, the chamber wall of the auxiliary chamber being partly formed by a diaphragm;
a partition member separating the main chamber and the auxiliary chamber from each other;
a communication passage passing through the partition member to allow the liquid to flow between the main chamber and the auxiliary chamber;
a vibrator for vibrating the liquid in the main chamber at a predetermined frequency, the vibrator including an oscillating piston installed in the communication passage, an electromagnetic rotary actuator to drive the oscillating piston at a predetermined frequency, and a rotating shaft connecting the oscillating piston with the rotary actuator, wherein the rotary actuator has a permanent magnet making up a part of the rotary actuator and mounted to the rotating shaft;
a bearing portion for supporting the oscillating piston and the rotating shaft, the bearing portion including a planar bearing and a journal portion engaging the planar bearing, wherein the journal portion is so formed as to introduce the liquid between the planar bearing and the journal portion; and
a holding portion for supporting the oscillating piston and the rotating shaft, the holding portion being provided on the side of one end portion of the rotating shaft to hold the one end portion rotatably.

2. The hydraulic vibration isolator according to claim 1, wherein the holding portion comprises a line contact portion formed in a plane perpendicular to an axis of the rotating shaft.

3. The hydraulic vibration isolator according to claim 2, wherein the line contact portion comprises one of two combinations, the two combinations comprising a combination of a spherical portion provided at a front end portion of the rotating shaft and a conical surface provided on the partition member side to engage the spherical portion and another combination of a conical portion formed at a front end side of the rotating shaft and a rotation defining raised surface, the rotation defining raised surface being provided on the partition member side, formed of a rotation defining surface of a raised curved portion, and adapted to engage the conical portion.

4. The hydraulic vibration isolator according to claim 1, wherein the journal portion is provided on the rotating shaft and an outer surface of the rotating shaft at the journal portion is formed with a recess to introduce the liquid.

5. The hydraulic vibration isolator according to claim 1, wherein the journal portion is provided on the rotating shaft and an outer surface of the rotating shaft at the journal portion is formed with a spiral groove to introduce the liquid.

6. The hydraulic vibration isolator according to claim 1, wherein the journal portion is provided on the rotating shaft and an outer surface of the rotating shaft at the journal portion is surface-textured or its surface roughness is increased to introduce the liquid between the outer surface and the planar bearing.

7. A hydraulic vibration isolator comprising:
a first linking member adapted to be mounted to a vibrating body side;
a second linking member adapted to be mounted to a member on a car body side;
an insulator installed between the first and second linking members to isolate vibrations from the vibrating body;
a main chamber defined by a chamber wall and sealed with a liquid or incompressible fluid, the chamber wall being partly formed by a part of the insulator;
an auxiliary chamber defined by a chamber wall and communicating with the main chamber through an orifice, the chamber wall of the auxiliary chamber being partly formed by a diaphragm;
a partition member separating the main chamber and the auxiliary chamber from each other;
a communication passage passing through the partition member to allow the liquid to flow between the main chamber and the auxiliary chamber;
a vibrator for vibrating the liquid in the main chamber at a predetermined frequency, the vibrator including an oscillating piston installed in the communication passage, an electromagnetic rotary actuator to drive the oscillating piston at a predetermined frequency, and a rotating shaft connecting the oscillating piston with the rotary actuator, wherein the rotary actuator has a permanent magnet making up a part of the rotary actuator and mounted to one end portion of the rotating shaft;
a bearing portion for supporting the oscillating piston and the rotating shaft, the bearing portion including a planar bearing and a journal portion engaging the planar bearing, wherein the journal portion is so formed as to introduce the liquid between the planar bearing and the journal portion;
a holding portion for supporting the oscillating piston and the rotating shaft, the holding portion being provided on the side of the other end portion of the rotating shaft to hold the other end portion rotatably; and
metallic magnetic elements provided around the permanent magnet and offset from the permanent magnet in an axial direction of the rotating shaft by a predetermined distance to produce a magnetic force acting between the permanent magnet and the metallic magnetic elements to force the rotating shaft toward the holding portion side.

8. The hydraulic vibration isolator according to claim 7, wherein the holding portion comprises a line contact portion formed in a plane perpendicular to an axis of the rotating shaft.

9. The hydraulic vibration isolator according to claim 8, wherein the line contact portion comprises one of two combinations, the two combinations comprising a combination of a spherical portion provided at a front end portion of the rotating shaft and a conical surface provided on the partition member side to engage the spherical portion and another combination of a conical portion formed at a front end side of the rotating shaft and a rotation defining raised surface, the rotation defining raised surface being provided on the partition member side, formed of a rotation defining surface of a raised curved portion, and adapted to engage the conical portion.

10. The hydraulic vibration isolator according to claim 7, wherein the journal portion is provided on the rotating shaft and an outer surface of the rotating shaft at the journal portion is formed with a recess to introduce the liquid.

11. The hydraulic vibration isolator according to claim 7, wherein the journal portion is provided on the rotating shaft and an outer surface of the rotating shaft at the journal portion is formed with a spiral groove to introduce the liquid.

12. The hydraulic vibration isolator according to claim 7, wherein the journal portion is provided on the rotating shaft and an outer surface of the rotating shaft at the journal portion is surface-textured or its surface roughness is increased to introduce the liquid between the outer surface and the planar bearing.

13. The hydraulic vibration isolator according to claim 7, wherein the permanent magnet is mounted to the rotating shaft by a predetermined fastening means without using an adhesive.

14. A hydraulic vibration isolator comprising:
a first linking member adapted to be mounted to a vibrating body side;
a second linking member adapted to be mounted to a member on a car body side;
an insulator installed between the first and second linking members to isolate vibrations from the vibrating body;
a main chamber defined by a chamber wall and sealed with a liquid or incompressible fluid, the chamber wall being partly formed by a part of the insulator;
an auxiliary chamber defined by a chamber wall and communicating with the main chamber through an orifice, the chamber wall of the auxiliary chamber being partly formed by a diaphragm;
a partition member separating the main chamber and the auxiliary chamber from each other;
a communication passage passing through the partition member to allow the liquid to flow between the main chamber and the auxiliary chamber;
a vibrator for vibrating the liquid in the main chamber at a predetermined frequency, the vibrator including an oscillating piston installed in the communication passage, an electromagnetic rotary actuator to drive the oscillating piston at a predetermined frequency, and a rotating shaft connecting the oscillating piston with the rotary actuator, wherein the rotary actuator has a permanent magnet making up a part of the rotary actuator and mounted to the rotating shaft;
fastening means to mount the permanent magnet to the rotating shaft without using an adhesive
a bearing portion for supporting the oscillating piston and the rotating shaft, the bearing portion including a planar bearing and a journal portion engaging the planar bearing, wherein the journal portion is so formed as to introduce the liquid between the planar bearing and the journal portion; and
a holding portion for supporting the oscillating piston and the rotating shaft, the holding portion being provided on the side of one end portion of the rotating shaft to hold the one end portion rotatably.

15. The hydraulic vibration isolator according to claim 14, wherein the holding portion comprises a line contact portion formed in a plane perpendicular to an axis of the rotating shaft.

16. The hydraulic vibration isolator according to claim 15, wherein the line contact portion comprises one of two combinations, the two combinations comprising a combination of a spherical portion provided at a front end portion of the rotating shaft and a conical surface provided on the partition member side to engage the spherical portion and another combination of a conical portion formed at a front end side of the rotating shaft and a rotation defining raised surface, the rotation defining raised surface being provided on the partition member side, formed of a rotation defining surface of a raised curved portion, and adapted to engage the conical portion.

17. The hydraulic vibration isolator according to claim 14, wherein the journal portion is provided on the rotating shaft and an outer surface of the rotating shaft at the journal portion is formed with a recess to introduce the liquid.

18. The hydraulic vibration isolator according to claim 14, wherein the journal portion is provided on the rotating shaft and an outer surface of the rotating shaft at the journal portion is formed with a spiral groove to introduce the liquid.

19. The hydraulic vibration isolator according to claim 14, wherein the journal portion is provided on the rotating shaft and an outer surface of the rotating shaft at the journal portion is surface-textured or its surface roughness is increased to introduce the liquid between the outer surface and the planar bearing.
